(19) United States
(12) Patent Application Publication
(10) Pub. No.: US 2018/0160703 A1
(43) Pub. Date: Jun. 14, 2018

(54) PULSE AND CEREAL PROTEIN FROZEN COMPOSITION

(71) Applicant: Conopco, Inc., d/b/a UNILEVER, Englewood Cliffs, NJ (US)

(72) Inventors: Loyd WIX, Rushden (GB); David John JUDGE, Odell (GB)

(73) Assignee: Conopco, Inc., d/b/a UNILEVER, Englewood Cliffs, NJ (US)

(21) Appl. No.: 15/738,483

(22) PCT Filed: Jun. 22, 2016
(86) PCT No.: PCT/EP2016/064473

§ 371 Date: Dec. 20, 2017

Related U.S. Application Data
(60) Provisional application No. 62/186,828, filed on Jun. 30, 2015.

(51) Int. Cl. A23G 9/38; A23G 9/32; A23L 33/185

(52) U.S. Cl. CPC A23G 9/38; A23G 9/327; A23V 2250/5484; A23V 2002/00; A23L 33/185

(57) ABSTRACT

A frozen confection which is essentially free of ingredients of animal origin, such as milk ingredients, yet which includes good quality protein. Notwithstanding the minimized or absent animal derived ingredients, the product provides the sensory experience of ice cream. The experience is reflected in texture, mouth feel and melt profile. The compositions of the invention is a frozen confection comprising: 1-20 wt % triglyceride oil, 0.5-15 wt % total protein, 10-40 wt % sugar solids and 0-1 wt % emulsifier and 0-1 wt % stabilizer wherein the protein comprises at least one cereal protein such as oat protein and at least one pulse protein such as pea protein.

### BACKGROUND OF THE INVENTION

Although many consumers enjoy frozen confections such as ice cream, some individuals are sensitive to the milk-based ingredients from which these treats are typically prepared. Therefore, some have turned to vegetable based frozen confections.

Frozen confections or other food products wherein part or all of dairy ingredients have been replaced have been described in the patent literature, including Cox, et al. EP 1967077,

Medina et al. WO2014/008580, Tergesen US Patent Application Publication No. US2014/0255591, Boursier et al. US Patent Application Publication No. US2011/0305740, Perks et al. WO2009/023560, Eisner et al. US Patent Application Publication No. US2008/0089990, CN103859129, Samoto et al. US Patent Application Publication No. US2014/0113866, Bilet US 2012/0121775, Colavito US 2011/0206808. Colavito WO 2013/019771, Carella et al. US 2014/0271993, Crank WO 2007/103753, Sabbagh et al. WO 2010/033985, CN 103349148, Jarrett WO 2006/096377, Eisner et al. US 2009/0011107, Back et al. US 2006/0127560, Tsujii et al. US 20070128323, CN102028089, WO 2009/063458, JP2006158391, Tabuteau et al. GB 2194877, JP11276086, Snowden et al. US 2007/0154611, CN1685920, Crank et al. WO 97/37547, Leusner et al. U.S. Pat. No. 4,696,826, and WO 86/02809.

Frozen confections or other food products wherein part or all of dairy ingredients have been replaced have been described in the non-patent technical literature as well, including Slind-Flop, “A new scoop for chef Leruth,” Restaurant Business (1986), Volume 85, Number 8, pp. 154-155, Simmons et al., “Cottonseed and soya protein ingredients in soft-serve frozen desserts,” Journal of Food Science, 1980, 45 (6), 1505-8, Lawhon, et al. Utilization of membrane-produced oilseed isolates in soft serve frozen desserts, Journal of the American Oil Chemists' Society, 1980, 57 (9), 302-6, Lightowler, et al., The Vegan Dairy, Nutrition and Food Science, 1998, (May-June), (3), 153-157, Ahanian, “Production of Ice Cream by Using Soy Milk, Stevie and Isomalt,” Advances in Environmental Biology (2014), 8(11S5), 9-16, Bisla, et al. “Development of ice-creams from soybean milk & watermelon seeds milk and evaluation of their acceptability and nourishing potential,” Advances in Applied Science Research (2012), 3(1), 371-376, and Iguttia, et al. “Substitution of ingredients by green coconut (Cocos nucifera L) pulp in ice cream formulation,” Procedia Food Science (2011), 1, 1610-1617.

Other literature includes Pereira, et al., “Influence of the partial substitution of skim milk powder for soy extract on ice cream structure and quality,” European Food Research and Technology (2011), 232(6), 1093-1102, Anon, “ADM offers soy as dairy protein alternative,” Decision News Media, 2007, (November 14), Kebary et al, “Quality of ice cream as influenced by substituting non-fat dry milk with whey-bean proteins coprecipitates,” Egyptian Journal of Dairy Science (1997), Volume 25, Number 2, pp.311-325, Anon, “Indulgent ice-cream,” Dairy Foods, 1994, 95 (6), 86, LaBell, “Multi-use milk substitute,” Food Processing, USA (1991), Volume 52, Number 11, pp. 118-120, Gupta, et al., “Fabricated dairy products,” Indian Dairyman (1987), Volume 39, Number 5, pp. 199-208, Regan, “Ben & Jerry Are Going to Make Non-Diary Ice Cream Flavors,” Time Magazine (Jun. 16, 2015), P1, and Hannigan, “Corn/soy-based frozen desserts: taste and nutrition made to order,” Food Engineering (1982), Volume 54, Number 3, 92 p.

Several nut-based frozen desserts are on the market in the United States, including So-Delicious Almond Milk Frozen Dessert (ingredients include almond milk (water, almonds), organic dried cane syrup, coconut oil, vanilla extract, natural flavor, gum arabic, carob bean gum, sea salt) and Almond Dream Non-Dairy Frozen Dessert (ingredients include filtered water, evaporated cane juice, almonds, expeller pressed oil (sunflower and/or safflower and/or canola), tapioca maltodextrin, natural vanilla extract, potato starch, guar gum, carob bean gum, carrageenan, soy lecithin, sea salt, natural flavors).

Some attention has been focused in recent years on the “quality” of various proteins. There are nine amino acids that cannot by synthesized by human and thus must be present in the diet. These essential amino acids are phenylalanine, valine, threonine, tryptophan, methionine, leucine, isoleucine, lysine, histidine. Milk contains all nine essential amino acids and many consumers recognize milk protein as a high quality protein. Vegetable proteins are generally regarded as poorer quality protein from a nutritional position as these proteins tend to be relatively poor in certain key essential amino acids. Thus, while vegetable-based frozen confections have been disclosed, it would be desirable to provide a vegetable based frozen confection which provides high quality protein.

### SUMMARY OF THE INVENTION

The invention relates to a frozen confection which is essentially free of ingredients of animal origin, such as milk ingredients, yet which includes good quality protein. Notwithstanding the minimized or absent animal derived ingredients, the product provides the sensory experience of ice cream. The experience is reflected in texture, mouth feel and melt profile.

The compositions of the invention include a triglyceride oil, such as coconut oil and a vegetable protein comprising pulse protein such as pea and cereal protein such as oat. The product may also include an emulsifier and/or a stabilizer. The invention also relates to a process for making the product, as described herein. More specifically, the frozen confection of the invention comprises 1-20 wt % triglyceride oil, 0.5-15 wt % total protein, 10-30 wt % sugar solids, 0-1 wt % emulsifier and 0-1 wt % stabilizer. The protein includes a combination of pulse protein and cereal protein. Preferably at least 40 wt %, more preferably at least 80 wt %, more preferably at least 90 wt % of the total protein is pulse protein or cereal protein. Ideally the protein of the frozen confection is at least 99 wt % of pulse and cereal protein. Preferably from 25 wt %-85 wt % of the combined pulse and cereal protein is pulse protein. The frozen confection is essentially free of protein, and preferably other ingredients derived from animals, as well. Preferably the vegetable proteins of the base frozen confections of the invention include all of the essential amino acids. Pulse proteins include pea protein, lentil protein, bean protein, lupin protein and soybean protein and mixtures thereof whereas cereal proteins include oat, wheat, rye, barley, rice, corn, sorghum, quinoa, buckwheat, fonio, triticale and millet and mixtures thereof.

The products of the invention will have special appeal to consumers who need to minimize animal protein intake, who have milk allergies or intolerances, who prefer not to eat animal-based products, who are concerned about the levels of cholesterol and saturated fat in milk, and who prefer products made from more sustainable ingredients. In addition, the plant-based ingredients used in the present compositions tend to be easier to obtain and less expensive than milk ingredients. Preferably the vegetable proteins of the base frozen confections of the invention include all of the essential amino acids.

For those who wish to avoid soy, the products of the invention may be essentially free of soy ingredients, as well.

For a more complete of the above and other features and advantages of the invention, reference should be made to the following description of the preferred embodiment.

### BRIEF DESCRIPTION OF THE DRAWINGS

FIG. 1 is a scanning electron micrograph of the 1% protein pea/oat ice cream of Example 1 at 16× magnification.

FIG. 2 is a scanning electron micrograph of the 1% protein pea/oat ice cream of Example 1 at 50× magnification.

FIG. 3 is a scanning electron micrograph of the 1% protein pea/oat ice cream of Example 1 at 100× magnification.

FIG. 4 is a scanning electron micrograph of the 1% protein pea/oat ice cream of Example 1 at 300× magnification.

FIG. 5 is a scanning electron micrograph of the 1% protein pea/oat ice cream of Example 1 at 1000× magnification.

FIG. 6 is a scanning electron micrograph of the 1% protein pea/oat ice cream of Example 1 at 4000× magnification.

### DETAILED DESCRIPTION OF THE INVENTION

As used in this application, “vegetable” refers to plant material that is not a fruit, a seed or a nut. Therefore, as used herein, “vegetable protein” does not include protein derived from nuts. As used in this application, “nuts” refer to a seed which comes from within a hard shell. Although technically categorized as a legume, for the purpose of this application, peanuts shall be considered a nut rather than a legume/vegetable. Nuts shall not be considered to be a “vegetable” in the present application.

The frozen confection is a frozen product such as ice cream, sherbet, water ice and the like. “Frozen,” as used herein, denotes that the product is solidified under freezing conditions to a hardpack or pumpable consistency which is not fluid or semi-fluid. The ice content of the frozen confection should be between 30 and 65% ice, and more preferably between 40% and 60% ice when measured at −18° C. The frozen confection is preferably a water-continuous emulsion. The term “ice cream” is used herein to denote a frozen confection which is similar to ice cream even if it would not meet the requirements for such, e.g., level of milk fat, in all jurisdictions.

By “base frozen confection” is meant the frozen confection but not including ingredients which will exist non-homogeneously in the confection, e.g., inclusions, such as visibly identifiable viscous flavorings like fudge and caramel swirls, nut pieces, cookie dough pieces, fruit pieces, baked pieces, candies, etc. The finished product is from 70% to 100% mix or base frozen confection, depending on the level of flavorings or inclusions. Inclusions (not part of the frozen matrix formed by the mix) range from 0% to 30 wt %, preferably from 0.5 to 30 wt %, especially from 10 to 30 wt %, of the frozen confection. Flavorings may be in the range of 0.01 to 20% wt of the frozen confection.

The pH of the frozen confections of the invention which simulate ice cream are typically 5 or above, especially 5.5-8.5, more preferably 5.5-8. Frozen confections simulating fruit products such as sherbet may have a lower pH, e.g., 3-7. Sherbets may include fruit juice or puree at a level of from 0.5 to 5 wt %, a food acid (typically citric acid) up to a level of 1%, and fat up to a level of 1′)/0.

The frozen confection of the invention is preferably aerated, i.e., it has an overrun of more than 10% and preferably less than 250%. More preferably, the overrun is between 30 and 200% overrun, and most preferably between 50 and 150% overrun.

Overrun: The extent of aeration of a product is measured in terms of “overrun”, which is defined as:

$$\% Overrun = \frac{weight of mix - weight of aerated product}{weight of aerated product} \times 100$$

where the weights refer to a fixed volume of mix or product. Overrun is measured at atmospheric pressure.

The source of proteins can include any vegetable source providing they function to help the creation of a good ice cream microstructure and provided they afford sufficient high quality protein. However, in accordance with the invention, the vegetable source includes a combination of pulse and cereal protein and optionally other vegetable proteins. The base frozen confections of the invention include 0.5-15 wt % total protein, especially from 0.8 to 10 wt % total protein, preferably from 1 to 5 wt % total protein most preferably from 1.5 to 3 wt % total protein. The protein is essentially free of protein from animal sources and is preferably at least 25 wt % vegetable protein, more preferably at least 50 wt % vegetable protein, most preferably at least 75 wt % vegetable protein. Ideally the protein is essentially free of non-vegetable protein.

Pulse proteins include pea protein, lentil protein, bean protein, lupin protein and soybean protein. Pea is preferred herein. Cereal proteins include oat, wheat, rye, barley, rice, corn, sorghum, quinoa, buckwheat, fonio, triticale and millet. Oat is preferred.

So long as at least one pulse and one cereal are included, types of vegetable protein which may be used herein include, but are not limited to, the following and combinations thereof: pea protein, chickpea beans, soy protein, wheat protein, cotton seed protein, sunflower seed, lupin protein, oat protein, lentil protein, sesame seed protein, canola protein, broad bean protein, horse bean protein, alfalfa protein, clover protein, rice protein, tapioca protein, potato protein, carob protein and corn protein. Preferably, the vegetable proteins of the invention are not fermented. Although some canola protein may be used preferably less than 5 wt % of the total protein in the base frozen confection is canola protein. Most preferably the base frozen confection is essentially free of canola protein base.

Cereal proteins are relatively poor in lysine whereas pulse protein is relatively poor in methionine. Thus the straightforward replacement of dairy protein with a vegetable protein leads to a product that no longer contains all the essential amino acids and thus is nutritionally inferior. However this deficiency in vegetable protein may be overcome by combining different vegetable proteins in accordance with the present invention so that the resulting product contains all the essential amino acids.

In terms of the microstructure, the protein should enable the creation of a fine microstructure where the average bubble diameter is between 20 and 200 um, preferably between 20 and 150 um and most preferably between 20 and 100 um in the produced ice cream product after hardening to below −18° C.

The vegetable protein is preferably added in the form of a powder, agglomerate or paste. Preferably the powder, agglomerate or paste, or other form in which the vegetable protein is added, is essentially free of starch hydrolyzate.

The base frozen confection will generally be essentially free of protein hydrolyzates.

The base frozen confection includes from 1-20 wt % fats, especially saturated oils, most preferably saturated vegetable oils. Preferred levels of fats are from 2 to 6 wt %, especially 3 to 5 wt %. By saturated oils is meant oils and fats having at least 30wt % of their fatty acid moieties as saturated fatty acids. Typical fats or oils that are used to make frozen confections include coconut oil, palm oil, and mixtures thereof. Saturated vegetable oils include, but are not limited to coconut, cocoa butter, illipe, shea, palm, palm kernel, and sal and mixtures thereof. Coconut oil and other vegetable oils are preferred. In some cases it may be desirable that the base frozen confection be essentially free of oils from animal origin such as butter oil.

While saturated vegetable oils are preferred, butter fat from cream and other dairy sources may be used if the product is not to be dairy free.

If it is desired to include vegetable oils and fats other than saturated oils, these may include, for instance, soybean oil, corn oil, peanut oil, safflower oil, flaxseed oil, cottonseed oil, rapeseed oil, canola oil, olive oil, sunflower oil, high oleic sunflower oil, and mixtures thereof. Total vegetable oil preferably constitutes from 60 to 100 wt % of the triglyceride fat in the base frozen confection , i.e. up to 40% of the triglyceride fat may come from a non-vegetable source, e.g. dairy.

The base mix of the frozen confections of the invention may optionally include nut solids, at from 0-10 wt %, especially 1-5 wt % of nut solids. Sources for nut solids include almonds, cashews, pecans, peanuts, macadamia nuts, brazil nuts, pine nuts, coconuts, butternuts, hazelnuts, walnuts, beechnuts, hickory nuts, chestnuts, pistachios, and mixtures thereof. Almonds are preferred.

The nut solids may be added to the liquid base mix pre-freezing in forms such as ground nuts, nut paste or nut butter.

If desired, the product may include an emulsifying agent. These induce the formation of de-stabilised fat in the freezing process. Typical emulsifiers used include mono-di-glycerides of saturated fatty acids, mono-di-glycerides of partially unsaturated fatty acids, tween, egg yolk, fractions of egg yolk, and lecithin. Preferably, the emulsifier used is a combination of saturated and unsaturated fatty acids of mono-di-glycerides. The total concentration of emulsifier is preferably between 0.05 and 1%, more preferably between 0.1 and 0.5wt %.

Stabilizers and/or thickeners are typically used to slow the melting rate of ice cream to provide resistance to structural change on storage, and improve mouth feel on consumption. Typical stabilisers used include: locust bean gum, tara gum, carrageenan, guar gum, sodium alginate, pectins, xanthan gum, gelatin, microcrystalline cellulose, citrus fibers and mixtures thereof. The total concentration of stabilizer is preferably 0-1 wt %, especially 0.1-1 wt %, more preferably 0.02-0.6 wt %, especially between 0.05 and 0.6%, most preferably between 0.1 and 0.4% based on the base frozen confection.

Generally the compositions of the invention will be naturally sweetened. Sugars control the amount of ice in the product and impact the sweetness of the ice cream or other frozen confection. Typical sugars include: sucrose, fructose, glucose, maltose, galactose, dextrose, corn syrups, maltodextrin, and lactose. Preferably the total concentration of sugar solids in the product is between 15 and 40%, and more preferably between 20 and 35%, based on the weight of the base frozen confection.

The composition may contain sugar alcohols, alone or in combination with one or more sugar compounds selected from monosaccharides, disaccharides, and oligosaccharides. Preferably, though, the maximum concentration of sugar alcohols is maximally 10% by weight of the base frozen confection, more preferred maximally 8% by weight of the base frozen confection. More preferably, the maximum concentration of sugar alcohols is 6% by weight. If used, sugar alcohols may be present at 0.5 wt % and above, more preferably 1 wt % and above. Alternatively and preferably sugar alcohols are absent from the composition. If present, the preferred sugar alcohols are erythritol, sorbitol, maltitol, lactitol, glycerol, and xylitol, and more preferred maltitol and erythritol. The composition may also contain soluble fibres like inulin and/or polydextrose and/or oligofructosaccharides in addition to or to replace part of the oligosaccharides.

Natural low- or non-caloric sweeteners such as stevia may be used at levels of from 0.01 to 0.15 wt %, especially 0.01 to 0.05 wt % of the base frozen confection. However, it is more preferred that the compositions of the invention are free of intense sweeteners (e.g., 10× or more sweetness than sucrose, especially 100× or more sweetness than sucrose) such as artificial sweeteners and stevia.

If it is desired to use artificial sweeteners, any of the artificial sweeteners well known in the art may be used, such as aspartame, saccharine, Alitame (obtainable from Pfizer), acesulfame K (obtainable from Hoechst), cyclamates, neotame, sucralose and the like, and mixtures thereof. The sweeteners are used in varying amounts of about 0.005% to 1% of the base frozen confection, preferably 0.007 wt % to 0.73 wt % depending on the sweetener, for example. Aspartame may be used at a level of 0.01 wt % to 0.15 wt % of the base frozen confection, preferably at a level of 0.01 wt % to 0.05 wt %. Acesulfame K is preferred at a level of 0.01 wt % to 0.15 wt % of the base frozen confection.

If desired, the product may include polydextrose. Polydextrose functions both as a bulking agent and as a fiber source and, if included, may be present at from 1 to 10 wt %, especially from 3 to 6 wt % of the base frozen confection.

Polydextrose may be obtained under the brand name Litesse from Danisco Sweeteners. Among other fiber sources which may be included in the compositions of the invention are fructose oligosaccharides such as inulin. Additional bulking agents which may be used include maltodextrin, sugar alcohols, corn syrup solids, sugars or starches. Total bulking agent levels in the base frozen confections of the invention, excluding any sugars, sugar alcohols or corn syrup solids, which are included with sweeteners above, may be from about 5 to 20 wt %, preferably 13 to 16 wt %. If desired, Sugar alcohols such as glycerol, sorbitol, lactitol, maltitol, mannitol, etc. may also be used to control ice formation. However, the present invention also contemplates formulations in which glycerol is excluded.

Flavorings may be included in the frozen confection of the invention, preferably in amounts that will impart a mild, pleasant flavor. The flavoring may be any of the commercial flavors employed in ice cream, such as varying types of cocoa, pure vanilla or artificial flavor, such as vanillin, ethyl vanillin, chocolate, extracts, spices and the like. It will further be appreciated that many flavor variations may be obtained by combinations of the basic flavors. The confection compositions are flavored to taste. Suitable flavorants may also include seasoning, such as salt, and imitation fruit or chocolate flavors either singly or in any suitable combination.

Malt powder can be used, e.g., to impart flavor, preferably at levels of from 0.01 to 3.0 wt % of the base frozen confection, especially from 0.05 to 1 wt %.

Preservatives such as potassium sorbate may be used as desired.

Adjuncts such as wafers, variegates, e.g., viscous, free oil-containing flavorings and sauces/coatings may be included as desired. Some of these may be in the form of inclusions such as viscous flavorings like fudge and caramel, nut pieces, cookie dough pieces, fruit pieces, dark and/or milk chocolate chunks, etc.

Water/moisture/ice will generally constitute the balance of the base frozen confection at, e.g., from 40-90 wt %, especially from 50-75 wt %.

Preferably, vegetable oils/fats used in the present invention are not partially hydrogenated. That is, it is preferred that the base frozen confection is essentially free of partially hydrogenated fats. Fat which has been hydrogenated to an extent such that there are still more than 2 wt % of unsaturated fatty acid moieties in the fat are considered partially hydrogenated herein. Even fully hydrogenated fats (fats hydrogenated so that there are 2 wt % or fewer unsaturated fatty acid moieties in the fat) are not preferred and the base frozen confection is essentially from of them, but may be used as ingredients in the composition in certain cases. The compositions of the invention preferably are essentially free, more preferably completely free, of partially and/or fully hydrogenated triglyceride fats. Hydrogenation of fats refers to the process wherein fats are chemically reacted by human intervention with hydrogen to replace one or more double bonds with hydrogen atoms.

All percentages herein are by weight unless otherwise stated or clearly required by context. Unless otherwise stated or clearly required by context, percentages are by weight of the base frozen confection.

By “essentially free” herein it is mean that the indicated ingredient is present at a level of 0.1 wt % or less of the base frozen confection.

Processes used for the manufacture of the product are similar to those used for conventional frozen confections. Typical process steps include: ingredient blending, pumping, pasteurization, homogenization, cooking, aeration, packaging and freezing.

Products can be manufactured by batch or by continuous processes, preferably continuous. Ingredients may be either liquid or dry, or a combination of both. Liquid ingredients can be blended by the use of positive metering pumps to a mixing tank or by in-line blending. Dry ingredients must be hydrated during the blending operations. This is most commonly accomplished by the use of turbine mixers in processing vats or by incorporating the dry material through a high speed, centrifugal pump. The blending temperature depends upon the nature of the ingredients, but it must be above the melting point of any fat and sufficient to fully hydrate proteins and any gums used as stabilizers.

Pasteurization is generally carried out in high temperature short time (HTST) units, in which the homogenizer is integrated into the pasteurization system. Protein is advisedly fully hydrated before adding other components which might interfere with the hydration.

### Materials and Formulations:

Protein content Supplier/wt %
Canola Isolex
Sodium Caseinate Na-Cas
Coconut oil: refined ex
Cargill.
Skimmed milk powder, ex
Dairy crest (Esher, Surrey,
UK). Protein content 35%.
Soy protein, Supro 120, ex
Solae. Protein content 90%.
Pea protein, Nutralys S85F,
ex Roquette. Protein content
80%.
Lupin protein Isolate, ex.
Prolupin. Protein content
90%.
Dextrose monohydrate: C-
Pharm Dex 02010 ex Cargill.
Sucrose, ex Tate and Lyle
(London, UK).
Glucose syrup 28DE: spray
dried C-Dry GL 01924, ex
Cargill.
Glucose-Fructose Syrup,
63DE, 78% Dry matter (LF9),
ex Cargill.
HP60: Mono-di-glycerides of
saturated fatty acids:
Grindsted Mono-Di-
Glycerides HP60, ex
DuPont Danisco. Made from
edible, fully hydrogenated
palm oil. Manufacturers
specifications: Total
monoglyceride 50-63%;
iodine value 3.
PS222: Mono-di-glycerides of
partially saturated fatty acids:
Grindsted Mono-Di-
Glycerides PS222, ex
DuPont Danisco. Made from
edible, refined palm based
fats and/or fully hardened
palm based fat.
Manufacturers specifications:
Total monoglyceride 64-88%;
iodine value < 30.
Locust Bean Gum (LBG),
LBG246 (GAX-00008), ex
DuPont
Guar gum: Grindsted Guar
250, ex DuPont Danisco.
Carrageenan L100: kappa-
carrageenan Genulacta
L100, ex CP Kelco.
Oat - PrOatein 54% Tate
and Lyle
Pea - Nutralys S85F 80% Roquette
MD40 is a
Maltodextrin available from
Grain Processing Corporation
HP60 mono-diglycerides available
from Garrett Ingredients, Bristol, UK

The full formulations for all the ice creams prepared in Example 1 are given below.

### Production of Ice Cream

(i) Preparation of the Mix

Dry sugars and stabilizers are mixed together and then dispersed in hot water (82 C) and stirred. Protein is added at 72° C. and stirred, after which oil is added. Flavor is added and stirred. The pre-mix is then heated to 80° C. and pasteurized for 30 seconds. It is then homogenized at 150-400 bar, more preferably 200-300 bar. A single stage valve homogeniser (APV Crepaco Homogeniser F-8831 3DDL) may be used. The mix is then cooled to 50° C.

(ii) Preparation of Frozen Ice Cream

The mixes are aerated and frozen to form ice cream. Overrun is at 30-200%, preferably 100 to 150%. The extrusion temperature is between −4 and −9° C. Products are hardened in a blast freezer at −30° C. for 2-4 hours before storage at −25° C.

### Methods of Analysis

(i) Scanning Electron Microscopy (SEM) of Ice Cream Products

The samples were cooled to −80° C. on dry ice and a sample section cut. This section, approximately 5 mm×5 mm×10 mm in size, was mounted on a sample holder using a Tissue Tek: OCT™ compound (PVA 11, Carbowax 5 and 85 non-reactive components). The sample including the holder was plunged into liquid nitrogen slush and transferred to a low temperature preparation chamber Oxford Instrument CT1500HF. The chamber was under vacuum, approximately 10-4 bar, and the sample was warmed up to −90° C. Ice was slowly etched to reveal surface details not caused by the ice itself, at this temperature under constant vacuum for 60 to 90 seconds. Once etched, the sample was cooled to −110° C. ending the sublimation, and coated with gold using argon plasma. This process also took place under vacuum with an applied pressure of 10⁻¹ millibars and current of 4 milliamps for 45 seconds. The sample was then transferred to a conventional Scanning Electron Microscope (JSM 5600), fitted with an Oxford Instruments cold stage at a temperature of −160° C. The sample was examined and areas of interest captured via digital image acquisition software.

### Methods to Measure Bubble Size

The air bubble size in the ice cream is extracted using imagine analysis tools. The gas bubble size (diameter) distribution as used herein is defined as the size distribution obtained from the two dimensional representation of the three dimensional microstructure, as visualized in the SEM micrograph, determined using the following methodology.

Samples are imaged at 3 different magnifications (for reasons explained below), and the bubble size distribution of a sample is obtained from this set of micrographs in three steps:

1. Identification and sizing of the individual gas bubbles in the micrographs 2. Extraction of the size information from each micrograph 3. Combination of the data from the micrographs into a single size distribution

All of these steps, other than the initial identification of the gas bubbles, can conveniently be performed automatically on a computer, for example by using software such as MATLAB R2006a (MathWorks, Inc) software.

### Identification and Sizing of the Individual Gas Bubbles in the Micrographs

Firstly, a trained operator (i.e. one familiar with the microstructures of aerated systems) traces the outlines of the gas bubbles in the digital SEM images using a graphical user interface. The trained operator is able to distinguish gas bubbles from ice crystals (which are present in frozen aerated products and are the same order of magnitude in size) because the gas bubbles are approximately spherical objects of varying brightness/darkness whereas ice crystals are irregular-shaped objects of a uniform grey appearance.

Secondly, the size is calculated from the selected outline by measuring the maximum area as seen in the two dimensional cross-sectional view of the micrograph (A) as defined by the operator and multiplying this by a scaling factor defined by the microscope magnification. The bubble diameter is defined as the equivalent circular diameter d:

d=2\sqrt{A/π}

This is an exact definition of the diameter of the two-dimensional cross-section through a perfect sphere. Since most of the gas bubbles are approximately spherical, this is a good measure of the size.

Extraction of the Size Information from Each Micrograph

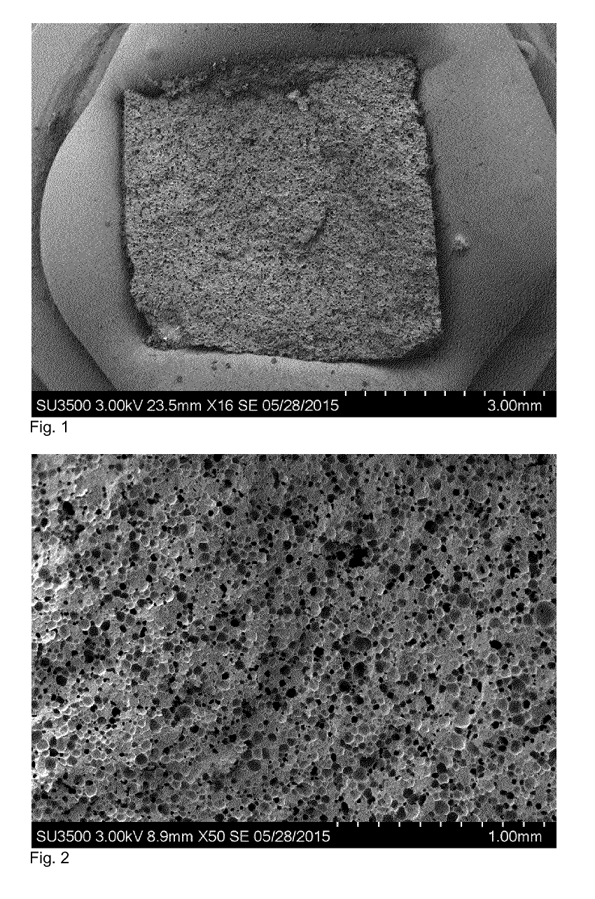

Gas bubbles which touch the border of a micrograph are only partially visible. Since it is not therefore possible to determine their area, they must be excluded. However, in doing so, systematic errors are introduced: (i) the number of gas bubbles per unit area is underestimated; and (ii) large gas bubbles are rejected relatively more often since they are more likely to touch the border, thus skewing the size distribution. To avoid these errors, a guard frame is introduced (as described in John C. Russ, “The Image Processing Handbook”, second edition, CRC Press, 1995). The guard frame concept uses a virtual border to define an inner zone inside the micrograph. The inner zone forms the measurement area from which unbiased size information is obtained, as illustrated in FIG. 1 (a schematic depiction of a micrograph, in which gas bubbles that touch the outer border of the micrograph have been drawn in full, even though in reality only the part falling within the actual micrograph would be observed.)

Bubbles are classified into 5 classes depending on their size and position in the micrograph. Bubbles that fall fully within the inner zone (labelled class 1) are included. Bubbles that touch the border of the virtual micrograph (class 2) are also included (since it is only a virtual border, there is fact full knowledge of these bubbles). Bubbles that touch the actual micrograph border (class 3) and/or fall within the outer zone (class 4) are excluded. The exclusion of the class 3 bubbles introduces a bias, but this is compensated for by including the bubbles in class 2, resulting in an unbiased estimate of the size distribution. Very large bubbles, i.e. those larger than the width of the outer zone (class 5), can straddle both the virtual (inner) border and the actual outer border and must therefore be excluded, again introducing bias. However, this bias only exists for bubbles that are wider than the outer zone, so it can be avoided by excluding all bubbles of at least this size (regardless of whether or not they cross the actual border). This effectively sets an upper limit to the gas bubble size that can be reliably measured in a particular micrograph. The width of the inner zone is chosen to be 10% of the vertical height of the micrograph as a trade-off between the largest bubble that can be sized (at the resolution of the particular micrograph) and the image area that is effectively thrown away (the outer zone).

There is also minimum size limit (at the resolution of the micrograph) below which the operator cannot reliably trace round gas bubbles. Therefore bubbles that are smaller than a diameter of 20 pixels are also ignored.

Combination of the Data from the Micrographs into a Single Size Distribution

As explained above, it is necessary to introduce maximum and minimum cut-off bubbles sizes. In order that these minimum and maximum sizes are sufficiently small and large respectively so as not to exclude a significant number of bubbles, some samples may need to be imaged at 3 different magnifications: e.g. 100×, 300× and 1000×. This occurs if there is a wide distribution in bubble sizes, and the skilled user can determine what magnifications are appropriate in order to capture the full size distribution: one magnification or more. As an example for the case of 3 different magnifications, each magnification yields size information in a different range, given below:

| Magnification | Minimum bubble size | Maximum bubble size |
|---|---|---|
| 100x | 20 μm | 83 μm |
| 300x | 6.6 μm | 28 μm |
| 1000x | 2.0 μm | 8.3 μm |

Thus bubbles as small as 2 μm and as large as 83 μm are counted. Visual inspection of the micrographs at high and low magnifications respectively confirmed that essentially all of the bubbles fell within this size range. The magnifications are chosen so that there is overlap between the size ranges of the different magnifications (e.g. gas bubbles with a size of 20-28 μm are covered by both the 100× and 300× micrographs) to ensure that there are no gaps between the size ranges. In order to obtain robust data, at least 500 bubbles are sized; this can typically be achieved by analysing one micrograph at 100×, one or two at ×300 and two to four at ×1000 for each sample.

The size information from the micrographs at different magnifications is finally combined into a single size distribution histogram. Bubbles with a diameter between 20 pm and 28 μm are obtained from both the 100× and 300× micrographs, whereas the bubbles with a diameter greater than 28 μm are extracted only from the 100× micrographs. Double counting of bubbles in the overlapping size ranges is avoided by taking account of the total area that was used to obtain the size information in each of the size ranges (which depends on the magnification), i.e. it is the number of bubbles of a certain size per unit area that is counted. This is expressed mathematically, using the following parameters:
N=total number of gas cells obtained in the micrographs
dₖ=the k^{th} outlined gas cell with k ∈ [1,N]
Aᵢ=the area of the inner zone in the i^{th} micrograph
Rᵢ=the range of diameters covered by the i^{th} micrograph (e.g. [20 μm,83 μm])
B(j)=the j^{th} bin covering the diameter range : [j W, (j+1) W)

The total area, S(d), used to count gas bubbles with diameter d is given by adding the areas of the inner zones (Aᵢ) in the micrographs for which d is within their size range (Rᵢ).

$$S ( d ) = {\sum }_{i \vert d ∈ {R}_{i}} {A}_{i}$$

The final size distribution is obtained by constructing a histogram consisting of bins of width W μm. B(j) is the number of bubbles per unit area in the j^{th} bin (i.e. in the diameter range j×W to (j+1)×W). B(j) is obtained by adding up all the individual contributions of the gas bubbles with a diameter in the diameter range j×W to (j+1)×W, with the appropriate weight, i.e. 1/S(d).

$$B ( j ) = {\sum }_{k ∈ D} 1 / S ( {d}_{k} )$$

where

Dᵢ={k|dₖ ∈ [jW,(j+1)W)}

Magnifications used are chosen by the skilled user in order to extract bubble size through the analysis software.

The bubble size distributions are conveniently described in terms of the normalised cumulative frequency, i.e. the total number of bubbles with diameter up to a given size, expressed as a percentage of the total number of bubbles measured.

Alternative expressions of bubble size distribution can also be used, e.g. D(3,2) (surface weighted mean), or D(1,0) the number mean.

For the present invention, we refer to either ranges of bubble size diameters or the D(3,2) surface weighted mean.

### EXAMPLE 1

### Ice Cream Produced Using Oat Protein

| | 1% Pea and |
|---|---|
| Ingredients | Oat protein |
| Water | 60.607 |
| Coconut Oil | 5 |
| HP60 | 0.15 |
| PS222 | 0.15 |
| Sucrose | 13 |
| Dextrose | 3 |
| 28DE | 7 |
| MD40 | 9 |
| Carrageenan | 0.015 |
| Kappa | |
| Guar | 0.15 |
| LBG | 0.15 |
| Protein (oat | 0.93 |
| protein | |
| concentrate) | |
| Nutralys pea | 0.65 |
| protein | |
| vanilla flavour | 0.148 |
| vanilla flavour | 0.05 |
| | 100 |
| Homogenizaion | 300 bar + 30 |
| pressure | |

### Results

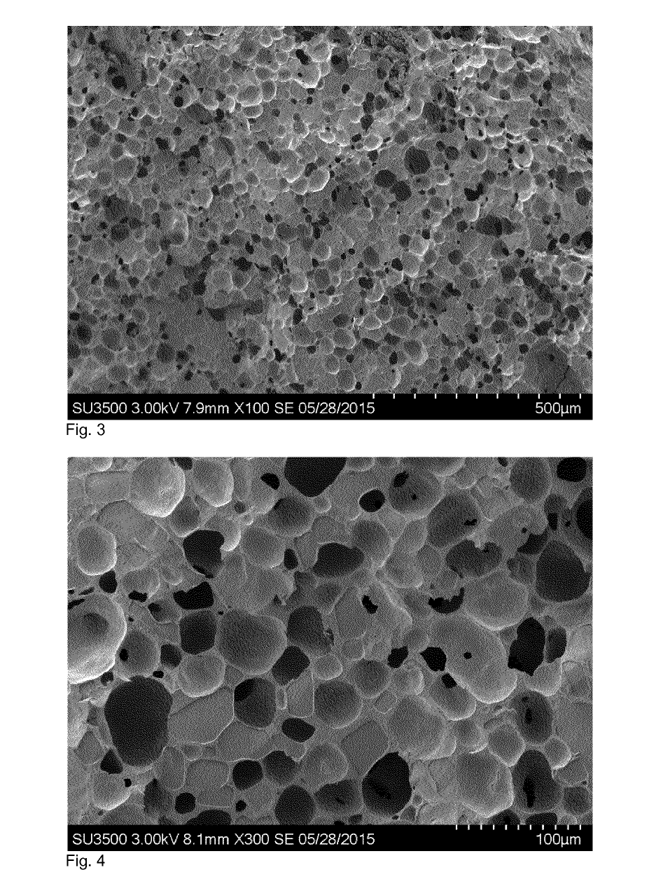

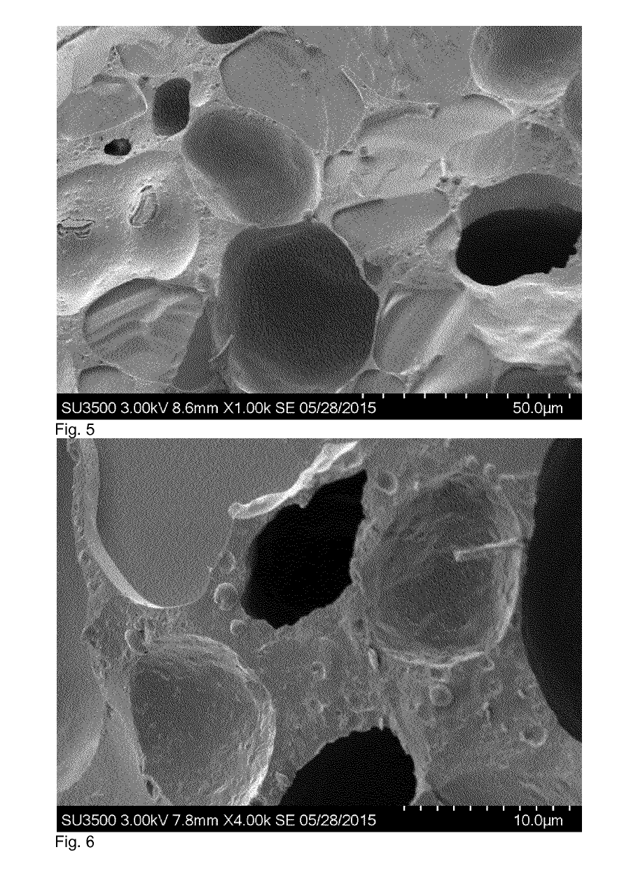

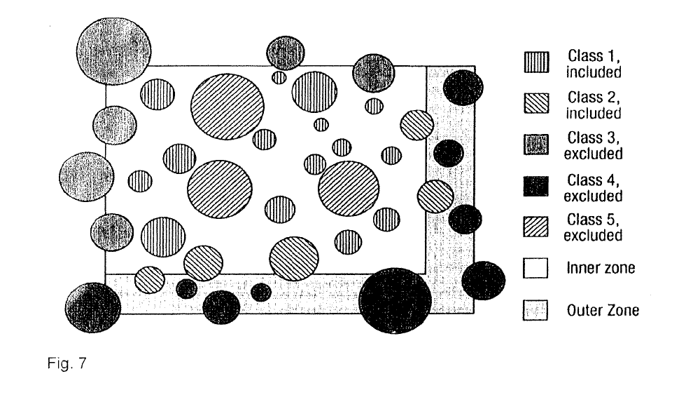

Scanning electron micrographs at various magnifications are shown in FIGS. 1-6 for the 1% protein oat/pea ice cream of Example 1. (Oat protein concentrate and pea protein isolate (total protein 1%))

Gas & Ice Structure

As can be seen in FIGS. 1-6, the product of the invention has a fine microscture including some microbubbles ie; a gas cell size of 20 μm. It has a homogenous in structure ie; gas cells with a network of ice in between. The figures show fat at the gas cell interfaces suggesting fat is helping to stabilise the air interface.

Conclusion

The sample containing 1% protein from PROATEIN oat protein concentrate and pea protein isolate appears to create a fine stable microstructure. In addition, it includes all of the essential amino acids without including any dairy protein.

It should be understood of course that the specific forms of the invention herein illustrated and described are intended to be representative only, as certain changes may be made therein without departing from the clear teaching of the disclosure. Accordingly, reference should be made to the appended claims in determining the full scope.

1. A frozen confection comprising:
1-20 wt % triglyceride oil, 0.5-15 wt % total protein, 10-40 wt % sugar solids and 0-1 wt % emulsifier and 0-1 wt % stabilizer wherein the protein comprises at least one cereal protein selected from the group of oat, wheat, rye, barley, rice, corn, sorghum, quinoa, buckwheat, fonio, triticale and millet and mixtures thereof, and at least one pulse protein selected from the group of pea, lentil, bean and lupin.

2. The frozen confection according to claim 1 wherein at least 40 wt % of the total protein is pulse protein or cereal protein.

3. The frozen confection according to claim 1 where at least 80 wt % of the total protein is pulse protein or cereal protein.

4. The frozen confection according to claim 1 wherein from 25 wt %-85 wt % of the combined pulse and cereal protein is pulse protein.

5. The frozen confection according to claim 1 which is essentially free of protein derived from animals.

6. The frozen confection according to claim 1 which is essentially free of ingredients derived from animals.

7. The frozen confection according to claim 1 wherein the cereal protein comprises oat and the pulse protein comprises pea.

8. The frozen confection according to claim 1 wherein the protein includes all of the essential amino acids.

9. The frozen confection according to claim 1 wherein the average bubble diameter is between 20 and 200 μm in the produced ice cream product after hardening to below −18° C.

10. The frozen confection according to claim 1 wherein the base confection is essentially free of protein hydroiyzates and the vegetable protein is added in a form essentially free of starch hydrolyzates.
